(19) United States
(12) Patent Application Publication
(10) Pub. No.: US 2026/0104204 A1
(43) Pub. Date: Apr. 16, 2026

(54) New type protective rotary kiln equipment

(71) Applicant: YINGNA MATERIALS TECHNOLOGY (ZHENJIANG)CO., LTD., Zhenjiang (CN)

(72) Inventor: Shetao ZHAO, Zhenjiang (CN)

(73) Assignee: YINGNA MATERIALS TECHNOLOGY (ZHENJIANG)CO., LTD., Zhenjiang (CN)

(21) Appl. No.: 19/418,985

(22) Filed: Dec. 13, 2025

Related U.S. Application Data
(63) Continuation of application No. PCT/CN2024/142543, filed on Dec. 26, 2024.

(30) Foreign Application Priority Data
Dec. 4, 2024 (CN) 202411766023.3

(51) Int. Cl. F27B 7/24; F27B 7/26; F27B 7/36; F27B 7/42

(52) U.S. Cl. CPC F27B 7/24; F27B 7/26; F27B 7/36; F27B 7/42

(57) ABSTRACT

The present disclosure relates to a novel protective rotary kiln apparatus. The novel protective rotary kiln apparatus includes a rotary kiln body, a transmission device, a sealing device, and a shell, where the rotary kiln body and the sealing device are located inside the shell, and the transmission device is entirely or partially located inside the shell; the transmission device is configured to drive the rotary kiln body to rotate; and the shell is stationary and keeps in a sealed state during production. The shell can provide heat preservation, wind protection, rain protection, dust protection, improved sealing performance, energy conservation, and protection for the rotary kiln body. Moreover, even if leakage occurs in the rotary kiln body, gas or solid leaking out can enter the shell, the shell keeps in the sealed state during production, and thus the gas or solid leaking from the rotary kiln body can be confined in the shell without further leaking to the exterior of the shell, and the rotary kiln body is isolated from external environment. The rotary kiln body is not in contact with the shell, so that the production safety can be essentially ensured. The shell is stationary, basically requires no maintenance, and can be safely used for a long time.

### TECHNICAL FIELD

The present disclosure belongs to the technical field of rotary kilns, and particularly relates to a novel protective rotary kiln apparatus.

### BACKGROUND OF THE INVENTION

Rotary kilns, also known as revolving kilns, are widely used in various industries such as the cement industry, the chemicals industry, the building materials industry, and the drying industry. The rotary kiln apparatus includes a cylinder body, a support device, a transmission device, a sealing device, a heating device, a feeding device, and a discharging device. Generally, the rotary kiln apparatus is large-sized and heavy, and the large-diameter revolving kiln used in industry is even heavier. Thus, it is of great importance to keep good sealing at two ends of the revolving kiln during rotation. At present, the sealing technology of the rotary kiln mainly includes: (1) a friction plate and a friction ring are pressed against each other through downward pressure of a cylinder or gravity to form dynamic sealing with good contact between the friction plate and the friction ring; (2) high-pressure compressed air environment is formed between a fixed kiln tail and a rotating cylinder body through high-pressure compressed air to prevent gas in the cylinder body from leaking out; and (3) the stroke of gas and material leakage is extended through a labyrinth structure and multi-stage filler sealing to increase a number and a length of the sealing surface.

However, the cylinder body is subjected to thermal expansion and contraction in the industrial application of the rotary kiln, and is generally heated unevenly in the axial direction and the radial direction. As a result, the cylinder body is deformed under a high temperature and a large dead weight. Sometimes sealing surfaces may be corroded by materials in the cylinder body. The sealing surfaces at two ends of the cylinder body are gradually destroyed by the above factors, resulting in gradual sealing failure and destruction and incapability to guarantee the production safety of the revolving kiln apparatus. With the progress of science and society, the requirements on environmental protection are increasingly higher. Moreover, the growing diversity of reactions in the rotary kiln puts forward higher sealing requirements on the rotary kiln apparatus. For example, during a hydrogen reduction reaction, silane deposition for preparation of silicon-carbon negative materials, etc. in the rotary kiln apparatus, silane and hydrogen are extremely flammable and explosive, and thus it is necessary to ensure zero leakage of the rotary kiln, which is a technical problem in the art.

### SUMMARY OF THE INVENTION

In view of the above problems, the present disclosure provides a novel protective rotary kiln apparatus. The novel protective rotary kiln apparatus includes a rotary kiln body, a transmission device, a sealing device, and a shell, where the rotary kiln body and the sealing device are located inside the shell, and the transmission device is entirely or partially located inside the shell; the transmission device is configured to drive the rotary kiln body to rotate; and the shell is stationary and keeps in a sealed state during production.

The transmission device may be entirely or partially located inside the shell. Optionally, when the transmission device is partially located inside the shell, a rotary member, in contact with the rotary kiln body, of the transmission device is located inside the shell, other parts of the transmission device are located outside the shell, and a transmission member of the transmission device penetrates the shell, with a penetration position sealed.

Optionally, a bottom of the shell is supported by the ground, or a base to support the shell to improve stability of the shell.

Optionally, the shell is internally provided with a support member, a bottom of the support member is fixedly connected to the bottom of the shell, and a top of the support member is rotatably connected to the rotary kiln body, to support the rotary kiln body in rotation and improve stability and safety of the rotary kiln body.

Optionally, the shell is made of stainless steel, the shell is connected to a gas inlet tube and a gas outlet tube, the gas inlet tube is connected to a protective gas source device and configured to input protective gas into the shell, and the gas outlet tube is connected to a tail gas treatment device and configured to collect, store, or treat waste gas discharged from the shell.

Further optionally, the protective gas is gas containing no oxygen. Preferably, the protective gas is inert gas containing no oxygen.

Further optionally, when production starts, a gas pressure in the shell is lower than a gas pressure in the rotary kiln body, and the shell is provided with a pressure gauge to monitor the pressure in the shell in real time;

when the sealing device of the rotary kiln body fails, gas in the rotary kiln body leaks into the shell, resulting in an increase in the gas pressure in the shell; and when the gas pressure in the shell increases to be identical to the pressure in the rotary kiln body, the gas in the rotary kiln body does not continue leaking.

Further optionally, when production starts, a gas pressure in the shell is higher than a pressure in the rotary kiln body, and the shell is provided with a pressure gauge to monitor the pressure in the shell in real time;

when the sealing device of the rotary kiln body fails, the protective gas in the shell enters the rotary kiln body, and the gas pressure in the shell decreases; and when the pressure gauge detects that the gas pressure in the casing decreases, it is determined that leakage occurs in the rotary kiln body.

Optionally, a wire of the transmission device and a wire of the rotary kiln body penetrate out of the shell and then are connected to an external power supply device, and positions where the wires penetrate out of the shell are sealed to prevent the shell from leaking.

Optionally, the shell is provided with an openable access door to facilitate repair and maintenance of apparatuses inside the shell; and the shell is provided with a window to facilitate observation of working conditions of the apparatuses inside the shell.

### BRIEF DESCRIPTION OF DRAWINGS

FIG. 1 is a schematic structural diagram of a novel protective rotary kiln apparatus;

FIG. 2 is another schematic structural diagram of a novel protective rotary kiln apparatus; and

FIG. 3 is yet another schematic structural diagram of a novel protective rotary kiln apparatus.

In the figures, 1-rotary kiln body, 2-transmission device, 3-shell, 4-support member, 5-gas inlet tube, 6-gas outlet tube, and 7-base.

### DETAILED DESCRIPTION OF THE INVENTION

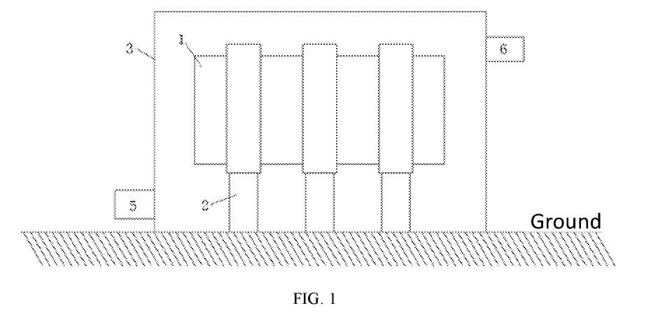

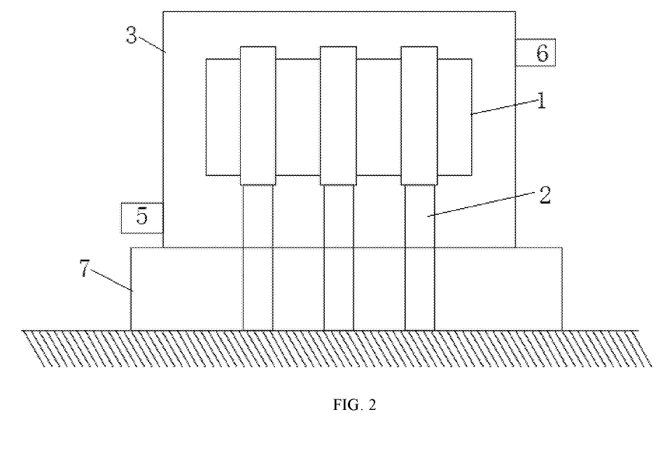

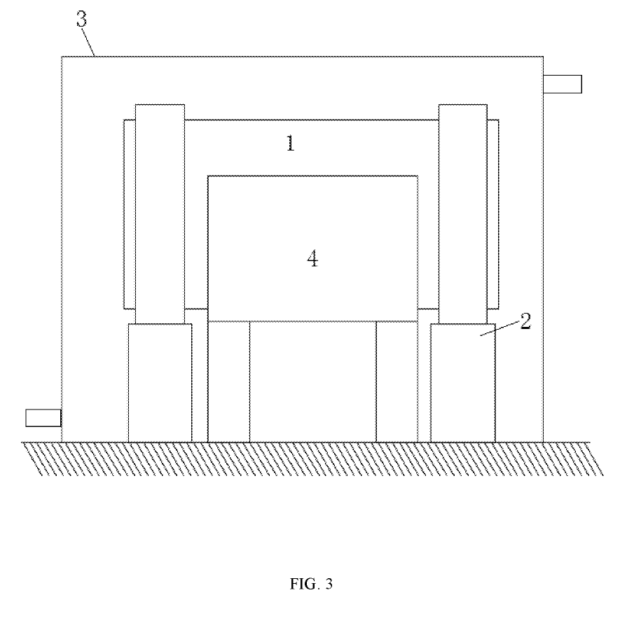

A novel protective rotary kiln apparatus is provided in the embodiment. As shown in FIGS. 1-3, the novel protective rotary kiln apparatus includes a rotary kiln body 1, a transmission device 2, a sealing device, and a shell 3, where the rotary kiln body 1 and the sealing device are located inside the shell 3, and the transmission device 2 is entirely or partially located inside the shell 3; the transmission device 2 is configured to drive the rotary kiln body 1 to rotate; and the shell 3 is stationary and keeps in a sealed state during production.

According to the present disclosure, the shell 3 is arranged outside a conventional rotary kiln device, and the rotary kiln body 1 and the sealing device are covered with the shell 3. The shell 3 can provide heat preservation and protection for the rotary kiln body 1, and the requirements on the rotary kiln body 1 and the sealing device are not too high. Even if leakage occurs in the rotary kiln body 1, gas or solid leaking out can enter the shell 3, the shell 3 keeps in the sealed state during production, and the gas or solid leaking from the rotary kiln body 1 can be confined in the shell 3 without further leaking to the exterior of the shell 3, so that the rotary kiln body 1 is isolated from external environment. The rotary kiln body 1 is not in contact with the shell 3, which can essentially ensure the production safety. The shell 3 is stationary, basically requires no maintenance, and can be safely used for a long time. When in use, reaction materials may be firstly added into the rotary kiln body 1, and the rotary kiln body 1 is closed and sealed. Then the shell 3 is closed, and protective gas is input into the shell 3. A temperature of the rotary kiln body 1 is increased, and a reaction starts. Also, the shell is also windproof, rainproof, and dustproof to prevent the external environment from interfering with the internal rotary kiln body, improve the safety and the sealing performance of the rotary kiln body, and avoid peeping at the structure of the rotary kiln body from the outside.

The transmission device 2 may be entirely or partially located inside the shell 3. Optionally, when the transmission device 2 is partially located inside the shell 3, a rotary member, in contact with the rotary kiln body 1, of the transmission device 2 is located inside the shell 3, other parts of the transmission device 2 are located outside the shell 3, and a transmission member of the transmission device 2 penetrates the shell 3, with a penetration position sealed.

Optionally, a bottom of the shell 3 is supported by the ground, or a base 7 to support the shell to improve the stability of the shell 3.

Further optionally, if the shell 3 is supported by the ground, a sealing member is arranged at a position, in contact with the ground, of the bottom of the shell 3 to keep the sealing performance of the shell 3. A bottom surface of the shell 3 is replaced with the ground, so that the weight of the shell 3 can be reduced and the cost can be lowered.

Optionally, the shell 3 is internally provided with a support member 4, a bottom of the support member 4 is fixedly connected to the bottom of the shell 3, and a top of the support member 4 is rotatably connected to the rotary kiln body 1 to support the rotating rotary kiln body 1 and improve the stability and safety of the rotary kiln body 1.

The position where the support member 4 is connected to the rotary kiln body 1 is different from the position where the transmission device 2 is connected to the rotary kiln body 1. Thus, the rotation of the rotary kiln body 1 driven by the transmission device 2 is not affected by the support member 4, the support member 4 functions like a bearing, and the support member 4 is stationary. The form of the support member 4 is not limited as long as it can be adapted to the shapes of the shell 3 and the rotary kiln body 1.

The size of the shell 3 is certainly greater than that of the rotary kiln body 1, and the shell 3 is arranged on the ground or the base to keep stationary, thereby having higher stability than the rotary kiln body 1 and the transmission device 2. The shell 3 is hollow inside, so that the dead weight of the shell 3 is reduced. The shape of the shell 3 is not limited as long as it is adapted to the shapes of the rotary kiln body 1 and the sealing device, so that the cost and the machining difficulty of the shell 3 are reduced, and in-situ transformation of the rotary kiln body 1 that has been mounted and operated is facilitated. The shell 3 has a simple structure, is stationary constantly, and is convenient to mount and maintain. After the support member 4 is additionally mounted in the shell 3, since the support member 4 is also stationary, the counterweight in the middle and lower part of the shell 3 is increased, and the stability of the shell 3 can be further enhanced.

Optionally, the shell 3 is made of stainless steel. The shell 3 is connected to a gas inlet tube 5 and a gas outlet tube 6, the gas inlet tube 5 is connected to a protective gas source device and configured to input protective gas into the shell 3, and the gas outlet tube 6 is connected to a tail gas treatment device and configured to collect, store, or treat waste gas discharged from the shell.

Further optionally, the protective gas is gas containing no oxygen. Preferably, the protective gas is inert gas containing no oxygen. The high-temperature gas or solid leaking from the rotary kiln body 1 enters the shell 3 and encounters gas in the shell 3. There is no oxygen in the shell 3, so that detonation or explosion of materials is avoided.

Further optionally, when production starts, a gas pressure in the shell 3 is lower than a gas pressure in the rotary kiln body 1, and the shell is provided with a pressure gauge to monitor the pressure in the shell in real time;

when the sealing device of the rotary kiln body fails, gas in the rotary kiln body leaks into the shell, resulting in an increase in the gas pressure in the shell; and when the gas pressure in the shell increases to be identical to the pressure in the rotary kiln body, the gas in the rotary kiln body does not continue leaking.

Further optionally, when production starts, a gas pressure in the shell is higher than a pressure in the rotary kiln body, and the shell is provided with a pressure gauge to monitor the pressure in the shell in real time;

when the sealing device of the rotary kiln body fails, the protective gas in the shell enters the rotary kiln body, and the gas pressure in the shell decreases; and when the pressure gauge detects that the gas pressure in the casing decreases, it is determined that leakage occurs in the rotary kiln body.

Optionally, a wire of the transmission device 2 and a wire of the rotary kiln body 1 penetrate out of the shell 3 and then are connected to an external power supply device, and positions where the wires penetrate out of the shell 3 are sealed to avoid leakage from the shell 3. If the rotary kiln body 1 is provided with an external heating device, the heating device is also arranged inside the shell 3, and a wire of the heating device penetrates out of the casing.

Optionally, the shell 3 is provided with an openable access door to facilitate repair and maintenance of apparatuses inside the shell 3; and the shell 3 is provided with a window to facilitate observation of working conditions of the apparatuses inside the shell 3.

Optionally, the rotary kiln body 1 may be further connected to a material feeding tube and a material discharging tube that are configured to input materials into the rotary kiln body and discharge materials out of the rotary kiln body respectively. The rotary kiln body may be further connected to a gas supply tube and a gas exhaust tube that are configured to input reaction gas into the rotary kiln body and discharge waste gas out of the rotary kiln body respectively.

Optionally, an outer side and/or an inner side of the shell are/is paved with heat preservation materials to perform further heat preservation on the rotary kiln body inside.

The rotary kiln body, the transmission device, the sealing device, and the support member of the present disclosure are all conventional industrial apparatuses in the industrial field, which are, for example, a cylindrical revolving kiln or a cement revolving kiln, a gear type transmission device or a roller type transmission device, a flexible sealing device, a labyrinth type sealing device, a cylinder type sealing device, a spring lever type sealing device, an end face friction sealing device with asbestos ropes, a graphite block sealing device, a mobile slip ring type sealing device, a laminated spring plate sealing device, etc. respectively, and can be improved by applying the technology of the present disclosure.

The novel protective rotary kiln apparatus of the present disclosure also has the beneficial effects as follows:

Heat preservation, energy conservation, and emission reduction: At present, the industrial rotary kilns generally have the thermal efficiency between 50%-85% and the total power of hundreds of kilowatts to thousands of kilowatts, and especially for large industrial kilns, the energy consumption cost is extremely high. The present disclosure can reduce the heat loss and the energy consumption by adding one shell outside the rotary kiln body and thus has high economic efficiency.

Wind and rain protection: The industrial rotary kiln has a large size and a length of tens of meters and is generally arranged outside in consideration of the construction cost of the factory building. The shell of the present disclosure can avoid the influence and damage of wind, rain, and snow on the rotary kiln body.

Dust protection: The working environment in an industrial factory building is complex, usually accompanied by dust, after long-term operation of the rotary kiln, a type of large system, dust is accumulated in an electric motor, etc., and some conductive metal dust or carbon dust lead to short circuit hazards of the electric motor.

Harmful gas protection: The environment in the workshop is complex, the air usually contains various trace harmful gas components, such as acid gas (HCl and H₂S), alkaline gas (NH₃, etc.), sulfide gas, etc. Many members of the rotary kiln body, the sealing device, and the transmission device, as well as various electrical appliances, electric motors, etc., are likely to be affected by harmful gas, including accelerated corrosion and aging of metal structural members. The shell of the present disclosure can prevent the harmful gas from damaging the apparatuses inside.

Improvement of the sealing performance of the process system: The research and development of the large kiln is hard-won, involving numerous technical secrets and technical details. After the shell is arranged outside, the exposure of the apparatuses inside is greatly reduced, which is conducive to the improvement of the sealing performance of the apparatus.

Enhancement of protection on workers: The rotary kiln body generally works at high temperature, and by arranging the shell on the outside, workers are less likely to touch the apparatuses inside. Thus, the safety under the working environment can be enhanced, burns and high-temperature injuries can be avoided, and the workers can be better protected.

### Embodiment 1

A novel protective rotary kiln apparatus is provided in the embodiment and configured to produce a carbon nanotube. As described above, the revolving kiln and its supporting electric heating furnace, transmission device, and sealing device are all arranged inside the shell. The revolving kiln is in a horizontal cylinder shape, with a diameter of 1.5 meters and a length of 20 meters. The revolving kiln is made of stainless steel 310S having a thickness of 20 mm, and has an effective reaction length of 15 meters. The electric heating furnace is arranged at an outer side of the revolving kiln, and has a length of 18 meters and an outer diameter of 2.7 meters. Two ends of the revolving kiln are provided with a kiln head and a kiln tail separately, and the kiln head, the kiln tail, and a middle part of the revolving kiln are sealed through combined scale structures. Two ends of a revolving cylinder body are connected to conventional transmission devices separately. Each transmission device includes a gear, a support wheel, and an electric motor and is configured to drive the revolving kiln to rotate.

The shell is stationary, is formed by welding a thin stainless steel sheet, and has a size of 24 meters in length, 5 meters in height, and 5 meters in width. The bottom of the shell is supported by a support frame. The wire of the transmission device and the wire of the revolving kiln penetrate out of the shell and are then connected to the external power supply device. The positions where the wires penetrate out of the shell are sealed to prevent the shell from leaking. A plurality of windows are provided on a top surface and a side surface of the shell.

During production of the carbon nanotube, flammable and explosive hydrocarbon gas, such as methane, is required to be used as a carbon source. When the methane is used during production of the carbon nanotube, the methane has its size enlarged after decomposed. Moreover, the content of hydrogen in tail gas in the revolving kiln is high. It is very dangerous if the tail gas in the revolving kiln leaks during production because the hydrogen exhibits a wide explosive range and an extremely-low lower explosive limit, with the explosive range of 4%-75%. Thus, the sealing performance of the revolving kiln takes a particularly critical role.

Two ends of the shell are connected to the gas inlet tube and the gas outlet tube separately, the gas inlet tube is connected to the nitrogen cylinder, and the gas outlet tube is connected to the tail gas treatment device. Nitrogen fills a space between the shell and the revolving kiln. After repeated replacement, the space between the shell and the revolving kiln contains extremely little oxygen, and a pressure of the nitrogen in the space is 0.005 MPa.

The two ends of the revolving kiln are connected to a raw gas tube and a tail gas tube separately, the raw gas tube and the tail gas tube penetrate out of the shell to be connected to a raw gas cylinder and the tail gas treatment device that are arranged outside the shell respectively. Sealing members are arranged at the positions where the raw gas tube and the tail gas tube penetrate the shell.

The revolving kiln is sealed after input with a catalyst and reaction materials. A temperature is slowly increased for 5 hours to increase a temperature of the revolving kiln to 750° C. Natural gas is introduced through the raw gas tube, where the flow rate of the natural gas is 1098.8 m³/h, and the pressure in the revolving kiln is 0.010 MPa. The tail gas is discharged through the tail gas tube.

Since the gas pressure in the shell is 0.005 MPa, and the pressure in the revolving kiln is 0.010 MPa, if the fish scale sealing devices at the kiln head and the kiln tail leak, the gas in the revolving kiln leaks into the shell, and no dangerous gas such as the natural gas and the hydrogen leak into the working environment outside the shell, so that explosion is prevented. The shell is a stationary object and has high safety after continuously used for a long time. The shell is provided with the pressure gauge to monitor the pressure in the shell in real time. When the sealing device of the revolving kiln fails, the gas in the revolving kiln leaks into the shell to lead to the increase in the gas pressure in the shell. When the gas pressure in the shell increases to be identical to the pressure in the revolving kiln, the gas in the revolving kiln does not continue leaking.

The shell in the embodiment can effectively prevent dust leakage from the revolving kiln, so that the production environment is greatly improved, workers are prevented from inhaling dust, and the product loss is avoided. Moreover, the shell can preserve heat of the revolving kiln, improve the thermal efficiency, reduce the energy consumption, and directly save on the production cost.

### Embodiment 2

A novel protective rotary kiln apparatus is provided in the embodiment and configured for limestone calcination experiments. As described above, the revolving kiln for lime calcination and its supporting roller type transmission device and sealing device are all arranged inside the shell. The roller type transmission device drives the revolving kiln for lime calcination to rotate, and the sealing device seals two ends of the horizontal revolving kiln in a conventional way. The shell is stationary, the bottom of the shell is supported by the ground, and the sealing member is arranged at the position where the bottom of the shell is in contact with the ground to keep the sealing performance of the shell. The shell is further internally provided with the support member, the bottom of the support member is arranged on the ground, and the top of the support member is rotatably connected to the revolving kiln for lime calcination to function like a bearing without affecting the rotation of the revolving kiln. The wire of the transmission device and the wire of the revolving kiln penetrate out of the shell and then are connected to the external power supply device, and the positions where the wires penetrate out of the shell are sealed. The shell is provided with the openable access door and the window.

The shell is made of stainless steel, two ends of the shell are connected to the gas inlet tube and the gas outlet tube separately, the gas inlet tube is connected to the nitrogen cylinder, and the gas outlet tube is connected to the tail gas treatment device.

The limestone entering the kiln has a particle size of 20 mm-40 mm and mass of 85.6 kg. A calcination temperature is 1170° C. When production starts, the gas pressure in the shell is higher than the gas pressure in the revolving kiln, and the shell is provided with the pressure gauge to monitor the pressure in the shell in real time. When the sealing device of the revolving kiln fails, nitrogen in the shell enters the revolving kiln, resulting in a decrease in the gas pressure in the shell. When the pressure gauge detects that the gas pressure in the casing decreases, it is determined that leakage occurs in the horizontal revolving kiln, and maintenance can be performed. Alternatively, when the gas pressure in the shell decreases to be identical to the pressure in the revolving kiln, the gas in the revolving kiln for lime calcination does not continue leaking.

The shell in the embodiment can effectively prevent dust leakage from the revolving kiln for lime calcination, so that the production environment is greatly improved, and workers are prevented from inhaling dust. Moreover, the shell can preserve heat of the revolving kiln experimental device for lime calcination, improve the thermal efficiency, reduce the energy consumption, and directly save on the production cost. The calcined lime has high quality and purity and desirable activity.

1. A novel protective rotary kiln apparatus, comprising a rotary kiln body, a transmission device, a sealing device, and a shell, wherein the rotary kiln body and the sealing device are located inside the shell, and the transmission device is entirely or partially located inside the shell; the transmission device is configured to drive the rotary kiln body to rotate; and the shell is stationary and keeps in a sealed state during production.

2. The novel protective rotary kiln apparatus according to claim 1, wherein when the transmission device is partially located inside the shell, a rotary member, in contact with the rotary kiln body, of the transmission device is located inside the shell, other parts of the transmission device are located outside the shell, and a transmission member of the transmission device penetrates the shell, with a penetration position sealed.

3. The novel protective rotary kiln apparatus according to claim 1, wherein a bottom of the shell is supported by the ground, or a base to improve stability of the shell.

4. The novel protective rotary kiln apparatus according to claim 1, wherein the shell is internally provided with a support member, a bottom of the support member is fixedly connected to the bottom of the shell, and a top of the support member is rotatably connected to the rotary kiln body, to support the rotary kiln body in rotation and improve stability and safety of the rotary kiln body.

5. The novel protective rotary kiln apparatus according to claim 1, wherein the shell is made of stainless steel, the shell is connected to a gas inlet tube and a gas outlet tube, the gas inlet tube is connected to a protective gas source device and configured to input protective gas into the shell, and the gas outlet tube is connected to a tail gas treatment device and configured to collect, store, or treat waste gas discharged from the shell.

6. The novel protective rotary kiln apparatus according to claim 5, wherein the protective gas is gas containing no oxygen.

7. The novel protective rotary kiln apparatus according to claim 5, wherein when production starts, a gas pressure in the shell is lower than a gas pressure in the rotary kiln body, and the shell is provided with a pressure gauge to monitor the pressure in the shell in real time;
when the sealing device of the rotary kiln body fails, gas in the rotary kiln body leaks into the shell, resulting in an increase in the gas pressure in the shell; and when the gas pressure in the shell increases to be identical to the pressure in the rotary kiln body, the gas in the rotary kiln body does not continue leaking.

8. The novel protective rotary kiln apparatus according to claim 5, wherein when production starts, a gas pressure in the shell is higher than a gas pressure in the rotary kiln body, and the shell is provided with a pressure gauge to monitor the pressure in the shell in real time;
when the sealing device of the rotary kiln body fails, the protective gas in the shell enters the rotary kiln body, and the gas pressure in the shell decreases; and when the pressure gauge detects that the gas pressure in the casing decreases, it is determined that leakage occurs in the rotary kiln body.

9. The novel protective rotary kiln apparatus according to claim 1, wherein a wire of the transmission device and a wire of the rotary kiln body penetrate out of the shell and then are connected to an external power supply device, and positions where the wires penetrate out of the shell are sealed to prevent the shell from leaking.

10. The novel protective rotary kiln apparatus according to claim 1, wherein the shell is provided with an openable access door to facilitate repair and maintenance of apparatuses inside the shell; and the shell is provided with a window to facilitate observation of working conditions of the apparatuses inside the shell.
